(19) United States
(12) Patent Application Publication
(10) Pub. No.: US 2026/0280966 A1
(43) Pub. Date: Sep. 17, 2026

(54) NETWORK DEVICE, CONTROL METHOD FOR NETWORK DEVICE, AND RECORDING MEDIUM

(71) Applicant: CANON KABUSHIKI KAISHA, Tokyo (JP)

(72) Inventor: Satoshi Takazawa, Kanagawa (JP)

(21) Appl. No.: 19/546,659

(22) Filed: Feb. 23, 2026

(30) Foreign Application Priority Data
Mar. 17, 2025 (JP) 2025-042135

(51) Int. Cl. H04L 41/0604; H04L 67/55

(52) U.S. Cl. CPC H04L 41/0627; H04L 67/55

(57) ABSTRACT

An image forming apparatus that provides a website including information about this image forming apparatus executes notification processing for performing notifications of information relating to the information forming apparatus via a push service to an application that has been installed on a mobile terminal by accessing a website and that has at least a portion of the functions of the website; transmits, to the application via the push service, a request for suppression of the notifications when beginning of procedures for resolving an abnormality in the image forming apparatus have been detected; and transmits, to the application via the push service, a removal request for the suppression of the notifications when completion of the procedures has been detected.

### BACKGROUND OF THE INVENTION

### Field of the Invention

The present disclosure relates to notifications of abnormalities in network devices.

### Description of the Related Art

Conventionally, a technology is known in which when an information processing apparatus detects an abnormality in a monitoring target, a manager of the monitoring target is notified. For example, in a network device such as an image forming apparatus, direct email notifications to the manager and event notifications to the monitoring system are possible, both having an abnormality detection as the trigger thereof. Japanese Unexamined Patent Application, First Publication No. 2003-316610 discloses a technology that performs notifications of events only for targets for which a subscription has been set.

However, in the case of notifications using the technology in Japanese Unexamined Patent Application, First Publication No. 2003-316610, although it is possible to limit the notifications to only the targets that need the information by using the subscription settings, notifications are performed to the notification targets each time that an abnormality is detected in the information processing apparatus. For example, in a case in which a plurality of errors have occurred in an information processing apparatus, even if one error is resolved during the error resolution task, if a different error remains, then the abnormality notification for this remaining error will be performed again. Due to this, there are cases in which even though the manager of the information processing apparatus and the person in charge of maintenance work understand the state of the information processing apparatus while they are performing the abnormality resolution task, they will receive unnecessary notifications.

### SUMMARY OF THE INVENTION

One goal of he present disclosure is to inhibit unnecessary notifications during a task for resolving abnormalities in a network device.

The network device of the present disclosure is a network device configured to provide a website comprising information about the network device, wherein the network device executes notification processing for performing notifications of information relating to the network device via a push service to an application that has been installed on a terminal by accessing the website and that has at least one function of the website; transmits, to the application via the push service, a request for suppression of the notifications when beginning of procedures to resolve an abnormality of the network device has been detected; and transmits, to the application via the push service, a request to remove the suppression of the notifications when completion of the procedures is detected.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a configuration of an information processing system.

FIG. 2 is a diagram showing one example of a hardware configuration of an image forming apparatus 101.

FIGS. 3A and 3B are diagrams showing one example of a hardware configuration of a mobile terminal 102 and a push server 103.

FIG. 4 is a diagram showing one example of a software module configuration for the image forming apparatus 101.

FIG. 5 is a diagram showing one example of a software module configuration for the push server 103.

FIG. 6 is a flowchart showing notification processing and notification suppression processing in an information processing system in a First Embodiment.

FIG. 7 is a diagram showing one example of a push notification display for the mobile terminal 102.

FIGS. 8A and 8B are diagrams showing one example of an operating screen.

FIG. 9 is flowchart showing notification processing and notification suppression processing in an information processing system in a Second Embodiment.

FIG. 10 is flowchart showing notification processing and notification suppression processing in an information processing system in a Third Embodiment.

FIG. 11 is a diagram showing one example of a timer setting screen in the Third Embodiment.

### DESCRIPTION OF THE EMBODIMENTS

### First Embodiment

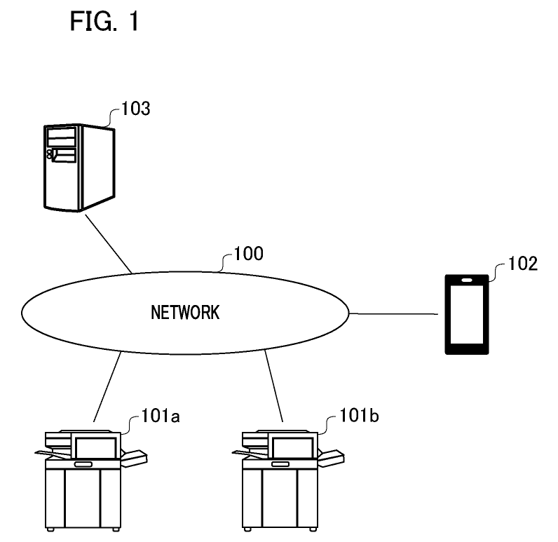

FIG. 1 is a diagram showing a configuration for an information processing system in the present embodiment. The information processing system according to the present embodiment is a system that notifies terminals of notifications relating to a network device via a push server from the network device. If the network device detects the occurrence of an event that occurs in this network device, the network device commands the push server so as to transmit a notification of the occurrence of the event to a terminal that has been registered as a notification destination. The push server that has received the notification from the network device notifies the terminal that has been registered as the notification destination of the occurrence of the event in the network device. It is thereby possible to notify a terminal of a manager and a maintenance worker of the network device of the occurrence of an event such as an error or the like in the network device, and to inform the manager and the maintenance worker of the occurrence of events. The information processing system has a network device, the push server 103 that provides a push service, and the mobile terminal 102 that uses a progressive web application, which is the transmission destination for notifications. Note that although in the present embodiment, an example is explained of a case in which the network device is the image forming apparatus 101, the present disclosure is not limited thereto. It is sufficient if the network device is a device that is able to perform communications, and for example, may also be a scanner, a 3D printer, a laptop computer, a smartphone, a smart home electronic, and the like.

Note that the information processing system of the present embodiment is realized by using progressive web apps (written below as a PWA). A PWA is a technology that allows a website to be used in the same manner as a local app, and there is no need to download and install an app corresponding to the information processing system. As long as the website is compatible with the PWA, the functions that are provided by the information processing system can be simply acquired and used via a web browser. In addition, in the PWA, it is possible to command push notifications via an API to the push server that is held by the vendors for each browser from the application server by utilizing a Service Worker function (written below as SW) that has been installed on the web browser. In addition, it is also possible to realize the display of an icon on a home screen, and the like by using the SW function.

The image forming apparatus 101 (an image forming apparatus 101a and an image forming apparatus 101b) is a network device that becomes a notification source. The image forming apparatus 101 notifies the PWA that has been provided by the image forming apparatus 101 and has been installed on the mobile terminal 102 of information relating to the image forming apparatus 101 via the push service. Therefore, if the image forming apparatus 101 detects the occurrence of an event such as the occurrence of an error, and the like, the image forming apparatus 101 performs a request to the push server 103 so as to send a notification of the event to the mobile terminal 102. In addition, the image forming apparatus 101 provides a website that includes information for the image forming apparatus 101 itself. The image forming apparatus 101 is, for example, an MFP (Multifunction Peripheral) that has as print function and a scan function. Using the print function, the image forming apparatus 101 receives print data that has been received via a network, and performs printing on actual sheets of paper, and the like by using a well-known printing technology such as an electrophotographic printing technology, an ink jet printing technology, and the like. The image forming apparatus 101 uses the scan function to read original documents via a scanner, and thereby convert the original documents to image data. Note that the image forming apparatus 101 may also be a single function printer that has only a print function.

The mobile terminal 102 is an information terminal for receiving event occurrence notifications for the image forming apparatus 101, which is a management target. The mobile terminal 102 has installed a browser 309, and is able to use the progressive web application (PWA). The mobile terminal 102 accesses the website that is provided by the image forming apparatus 101 and includes information for the image forming apparatus 101, and installs a progressive web application having at least a portion of the functions of this website via the browser 309. A service worker 311 has been installed on the browser 309. In addition, the mobile terminal 102 has been registered in the push server 103 as a notification target for the image forming apparatus 101. The mobile terminal 102 is, for example, a smartphone. Note that it is sufficient if the mobile terminal 102 is a terminal that is able to receive events, and may also be a personal computer, a tablet, and the like.

The push server 103 is an information processing apparatus that provides a push service. The push service realizes push notifications to the mobile terminal 102 from a notification transmission unit 408, which is part of the image forming apparatus 101. The push server 103 is prepared by the browser vender in order to provide the push service in the PWA. The notification destinations for notifications for the image forming apparatus 101 are registered in advance in the push server 103. In the present embodiment, the mobile terminal 102 is registered in the push server 103 as the notification destination for notifications for the image forming apparatus 101. The push server 103 transmits notifications from the image forming apparatus 101 to the mobile terminal 102, which has been registered as the notification destination for notifications from the image forming apparatus 101. Note that in addition to one or more information processing apparatuses, the push server 103 may also be realized by a virtual machine (a cloud service) that uses resources that have been provided by a data center including the information processing apparatus, and a combination thereof.

The image forming apparatus 101, the push server 103, and the mobile terminal 102 are connected via a network 100. Note that it is sufficient if the image forming apparatus 101 and the push server 103, as well as the push server 103 and the mobile terminal 102 are connected so as to be able to communicate. It is sufficient as long as the network 100 is configured so as to be able to send and receive data, and the communications format is not limited. For example, the network 100 may be configured by any one of a LAN, a WAN, a cellular network such as LTE, 5G, and the like, a wireless network, a phone line, a leased digital line, and the like, and may also be configured by a combination thereof.

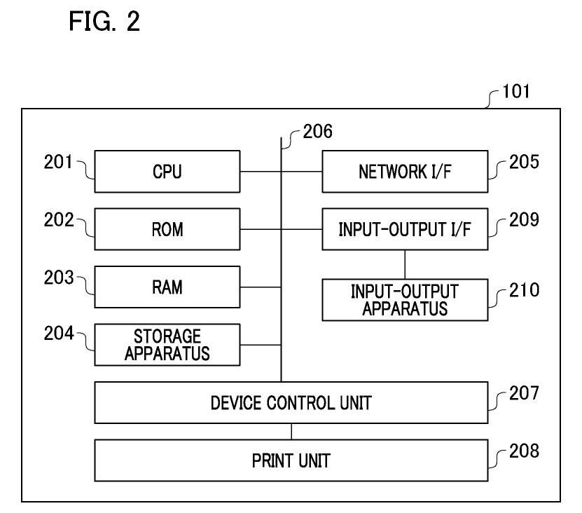

FIG. 2 is a diagram showing a hardware configuration of the image forming apparatus 101. The image forming apparatus 101 has a CPU 201, a ROM 202, a RAM 203, a storage apparatus 204, a network I/F 205, an internal bus 206, a device control unit 207, a print unit 208, an input-output I/F 209, and an input-output apparatus 210.

The CPU (central processing unit) 201 controls the entirety of the image forming apparatus 101 by integrally controlling each device via the internal bus 206. The ROM (Read Only memory) 202 stores programs including a basic control program for the image forming apparatus 101, and the like. The RAM (Random Access Memory) 203 functions as a memory and a work area for the CPU 201. In addition, the RAM 203 stores information for events that have occurred in the image forming apparatus 101, each type of counter information, consumption amount information for consumable products, each type of log, and the like. The storage apparatus 204 is, for example, an external storage apparatus such as an HDD (hard disk drive), an SSD (solid state drive), and the like. The storage apparatus 204 stores programs, image data, and the like. In addition, the storage apparatus 204 is able to store event information, each type of counter information, consumption amount information for consumable products, and each type of log instead of the RAM 203. The CPU 201 integrally controls each configuration that is connected to the internal bus 206 by executing programs that have been stored on a memory (the ROM 202, and the storage apparatus 204).

The network I/F 205 performs one-directional and two-directional data exchanges with external devices such as the mobile terminal 102, the push server 103, and the like via the network 100. The device control unit 207 controls the print unit 208 according to print requests and the like. The print unit 208 prints original documents that have been read by a reader and image data that has been stored on the storge apparatus 204 on a recording medium (for example, sheets of paper). In addition, the image forming apparatus 101 may also have a scanner unit that reads and converts paper original documents into image data via a scanner. The CPU 201 performs execution processing for programs along with the ROM 202 and the RAM 203, and also performs processing that records image data on a recording medium such as the storage apparatus 204, and the like. The input-output apparatus 210 receives inputs (print commands, scan commands, button inputs, and the like) from a user. The input-output I/F 209 transmits the inputs of the user that have been received by the input-output apparatus 210 to each processing unit. The CPU 201, the ROM 202, the RAM 203, the storage apparatus 204, the network I/F 205, and the device control unit 207 are connected to the internal bus 206.

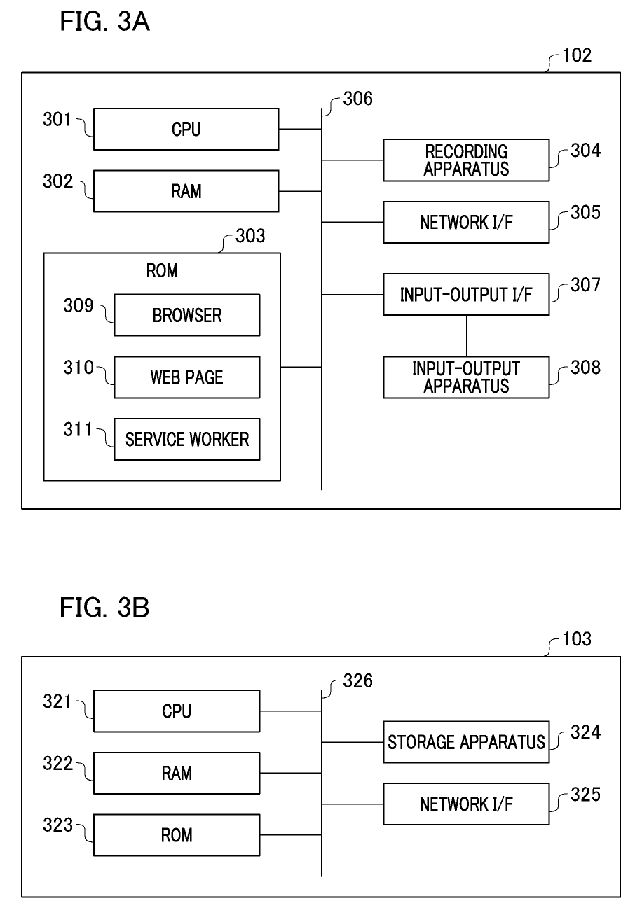

FIG. 3A is a diagram showing a hardware configuration of the mobile terminal 102. The mobile terminal 102 has a CPU 301, a RAM 302, a ROM 303, a storage apparatus 304, a network I/F 305, an internal bus 306, an input-output I/F 307, and an input-output apparatus 308. The CPU 301 controls the entirety of the mobile terminal 102 by integrally controlling each configuration via the internal bus 306. The ROM 303 stores programs and the like. The RAM 302 functions as a memory and a work area for the CPU 301. The CPU 301 executes each type of control processing by expanding and executing a program that has been stored on the ROM 303 on the RAM 302. The storage apparatus 304 stores programs and each type of information. In addition, the storage apparatus 304 is able to store each type of information instead of the RAM 302.

The ROM 303 has the browser 309, a webpage 310, and the service worker 311. The browser 309 is a web browser that has been installed on the mobile terminal 102, and is an application program for viewing a website. The webpage 310 is a module for performing communication control for displaying the webpage. In the present embodiment, the webpage 310 performs control for displaying, via the browser 309, the webpage that is provided by the image forming apparatus 101.

The service worker 311 is a script that has been installed on the browser 309 and is executed in the background of the browser 309 separately from the webpage 310. The service worker 311 functions as a proxy between the browser 309 and a webserver such as the push server 103 and the like. The service worker 311 in the present embodiment controls push notifications from the image forming apparatus 101 via the push server 103. In the present embodiment, the service worker 311 functions as a setting unit that sets suppression of notifications and the removal of this suppression according to requests from the image forming apparatus 101. Specifically, the service worker 311 performs control such that notifications that are transmitted from the image forming apparatus 101 are not displayed based on a notification suppression request from the image forming apparatus 101. In addition, the service worker 311 performs control so as to resume the display of notifications that are transmitted from the image forming apparatus 101 based on a notification suppression removal command from the image forming apparatus 101. In the present embodiment, the service worker 311 performs settings to not perform notifications via the input-output apparatus 308 of information relating to the image forming apparatus 101 based on notification processing based on a request to suppress the notifications, and also removes these settings based on a removal request for suppression of the notifications

The network I/F 305 exchanges data in one direction or both directions with external apparatuses such as the image forming apparatus 101, the push server 103, and the like, via the network 100. Each configuration inside of the mobile terminal 102 is connected to the internal bus 306. The input-output apparatus 308 is an operating unit such as a touch panel and the like. The input-output apparatus 308 receives inputs from the user. In addition, the input-output apparatus 308 performs the display of screens to the user. The input-output I/F 307 connects each configuration of the mobile terminal 102 with the input-output apparatus 308. The input-output I/F 307 controls inputs from the input-output apparatus 308 and outputs toward the input-output apparatus 308.

FIG. 3B is a diagram showing a hardware configuration of the push server 103. The push server 103 has a CPU 321, a RAM 322, a ROM 323, a storage apparatus 324, a network I/F 325, and an internal bus 326. The CPU 321 controls the entirety of the push server 103 by integrally controlling each configuration via the internal bus 326. The ROM 323 stores programs and the like. The RAM 322 functions as a memory and a work area for the CPU 301. The CPU 321 executes each type of control processing by expanding a program that has been stored on the ROM 323 onto the RAM 322 and executing this program.

The storage apparatus 324 stores programs, image data, and each type of information. The push server 103 is able to communicate with the image forming apparatus 101 and the mobile terminal 102 on the network 100 via the network I/F 325. The internal bus 326 is connected to the RAM 322, the ROM 323, the storage apparatus 324, and the network I/F 325.

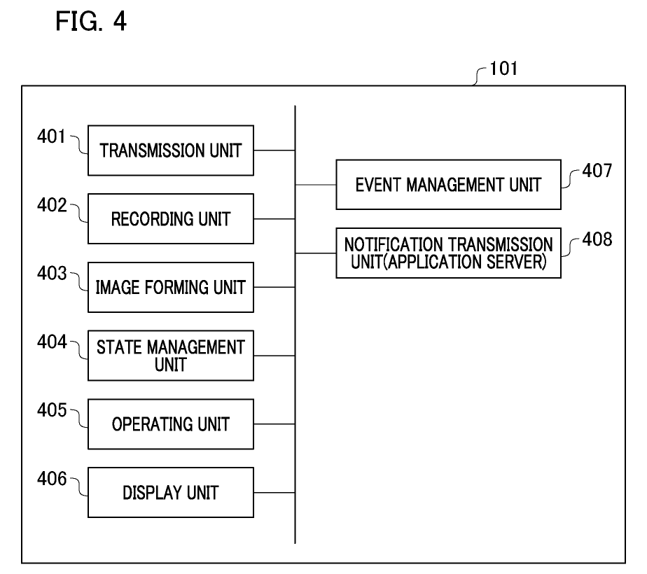

FIG. 4 is a diagram explaining a module configuration for software of the image forming apparatus 101. The software module of the image forming apparatus 101 is realized by the CPU 200 reading out and executing a program from the ROM 202. The image forming apparatus 101 has a transmission unit 401, a storage unit 402, an image forming unit 403, a state management unit 404, an operating unit 405, a display unit 406, an event management unit 407, and a notification transmission unit (application server) 408.

The transmission unit 401 collects device information and information for events that have occurred in the image forming apparatus 101 and transmits this information to an external apparatus (not shown). The transmission unit 401 acquires information relating to the image forming apparatus 101 (referred to below as device information), each type of counter information, consumption amount information for consumable products, and the like from the storage apparatus 204. The device information includes identification information for the image forming apparatus 101 (a serial number), network information (an IP address), operating information, and the like. The transmission and reception of data by the image forming apparatus 101 uses, for example, a communications protocol such as HTTPS.

The storage unit 402 performs control such as the storage and readout of information to the ROM 202, the RAM 203, the storage apparatus 204, and the like. In addition, the storage unit 402 stores the necessary management information for the management of the image forming apparatus 101. The management information includes, for example, firmware information, device information such as a serial number of the image forming apparatus 101 and the like, each type of counter information, consumption amount information for consumable products, an operation history for the image forming apparatus 101, history information showing various abnormal states (log data), and the like. Furthermore, the management information also includes information relating to the push server 103 as a notification destination for the event occurrence notifications, and information relating to the mobile terminal 102 that is registered as a target of the push notifications.

The image forming unit 403 generates and outputs print data to be sent to the print unit 208. The state management unit 404 manages the state of the image forming apparatus 101. For example, the state management unit 404 performs management of abnormal states of the image forming apparatus 101. In addition, the state management unit 404 performs management of the counter information and management of the notification information. The counter information includes, for example, a value that has counted the number of sheets printed by the image forming apparatus 101 using a sensor or the like, and consumption amount information showing a consumption amount of a part, and a remaining amount of consumable products such as a toner bottle and the like. In addition, the state management unit 404 performs print management.

The operating unit 405 receives operating commands for the image forming apparatus such as print commands from the user, and the like. The display unit 406 performs control of the display of a UI screen relating to the image forming apparatus 101 to the user. For example, the display unit 406 controls the display of a UI screen for state information for the image forming apparatus 101, consumption rate information for each type of consumable product (including a remaining amount of toner), settings information, and the like.

The event management unit 407 creates and manages event information by receiving events that occur in the image forming apparatus 101. The event information that is managed by the event management unit 407 includes events for print jobs that are created by the user of the image forming apparatus 101, abnormalities (errors), general status information for the image forming apparatus 101, and the like. For example, urgent errors such as hard disk errors, and the like, and errors such as paper jams, and warning level errors for the toner, and the like, are given as examples of errors for the image forming apparatus 101. When the event management unit 407 creates event information by detecting event occurrence, the event management unit 407 transmits a command (request) for notification of the event to the notification transmission unit 408.

The notification transmission unit 408 is an application server that performs notifications to the mobile terminal 102 that is the notification target via the push server 103. The notification transmission unit 408 first edits the format for performing the push notification based on the command from the event management unit 407. Then, the notification transmission unit 408 transmits each type of request for the mobile terminal 102 that is the notification target that is registered in advance to the push server 103. In this manner, in the present embodiment, the mobile terminal 102 is notified of events for the image forming apparatus 101 via the push server 103 according to the series of processing for the event management unit 407 and the notification transmission unit 408. In the present embodiment, the event management unit 407 and the notification transmission unit 408 function as a notification means that executes notification processing for performing notifications via the push service to a PWA that is installed on the mobile terminal 102 of information relating to the image forming apparatus 101. In addition, the event management unit 407 and the notification transmission unit 408 also function as a first transmission unit that transmits requests via the push service for suppressing notifications to the mobile terminal 102 when the beginning of procedures for resolving an abnormality of the image forming apparatus 101 has been detected. In addition, the event management unit 407 and the notification transmission unit 408 also function as a second transmission unit that transmits, via the push service, removal requests for the suppression of notifications to the mobile terminal 102 when the completion of the procedures for resolving the abnormality of the image forming apparatus 101 is detected. In addition, the notification transmission unit 408, which is an application server, generates and provides a webpage (website) for display on the browser 309 of the mobile terminal 102. In addition, the notification transmission unit 408, which is the application server, provides to the mobile terminal 102 a progressive web application that has at least a portion of the functions of the website that is provided by the notification transmission unit 408.

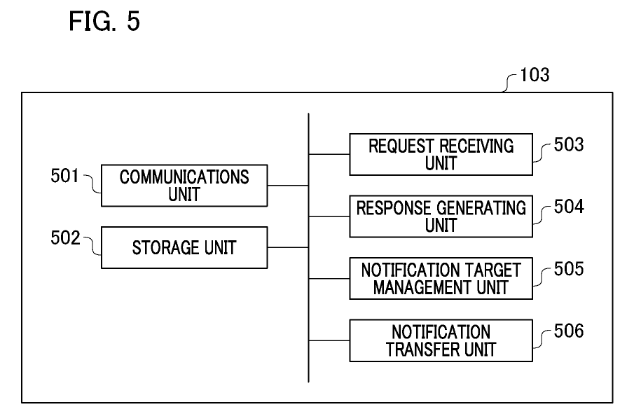

FIG. 5 is a diagram explaining a module configuration of software for the push server 103. The software module for the push server 103 is realized by the CPU 321 reading out and executing a program from the ROM 323. The push server 103 has a communications unit 501, a storage unit 502, a request receiving unit 503, a response generating unit 504, a notification target management unit 505, and a notification transfer unit 506.

The communications unit 501 performs communications with external devices such as the image forming apparatus 101, the mobile terminal 102, and the like. For example, the communications unit 501 receives push notification requests that are transmitted from the image forming apparatus 101. In addition, the communications unit 501 transmits push notifications to the browser 309 of the mobile terminal 102. The storage unit 502 performs control such as the storage and readout of information to the RAM 322, the ROM 323, and the storage apparatus 324, and the like. In the present embodiment, the storage unit 502 manages information such as information for the push notification target terminal, information for push notification requests, and the like.

The request receiving unit 503 receives requests from external devices such as the image forming apparatus 101, the mobile terminal 102, and the like. For example, the request receiving unit 503 receives registration requests for push notification targets from the browser 309 of the mobile terminal 102. In addition, the request receiving unit 503 receives requests for push notifications, requests for suppression of notifications, and requests to remove suppression of notifications from the notification transmission unit 408 of the image forming apparatus 101.

The response generating unit 504 generates responses to requests. In the present embodiment, the response generating unit 504 generates responses to requests to be registered as a push notification target from the browser 309 of the mobile terminal 102. Responses to requests for registration as a push notification target are push subscription objects, which will be explained below. The push subscription object that has been generated by the response generating unit 504 is transmitted to the browser 309, which is the request transmission source, via the communications unit 501.

The notification target management unit 505 manages information for terminals that have been registered as push notification targets. The information that is managed by the notification target management unit 505 includes, for example, an identifier for identifying a target terminal, a push subscription object, and the like. The notification transfer unit 506 transfers the notification that has been received from the image forming apparatus 101 to the notification target terminal based on endpoint information that is included in the push notification request that has been received from the notification transmission unit 408 of the image forming apparatus 101. The notification includes, for example, information for an error that has occurred in the image forming apparatus 101, information for a consumption amount of a consumable product, notices from the manager, and the like.

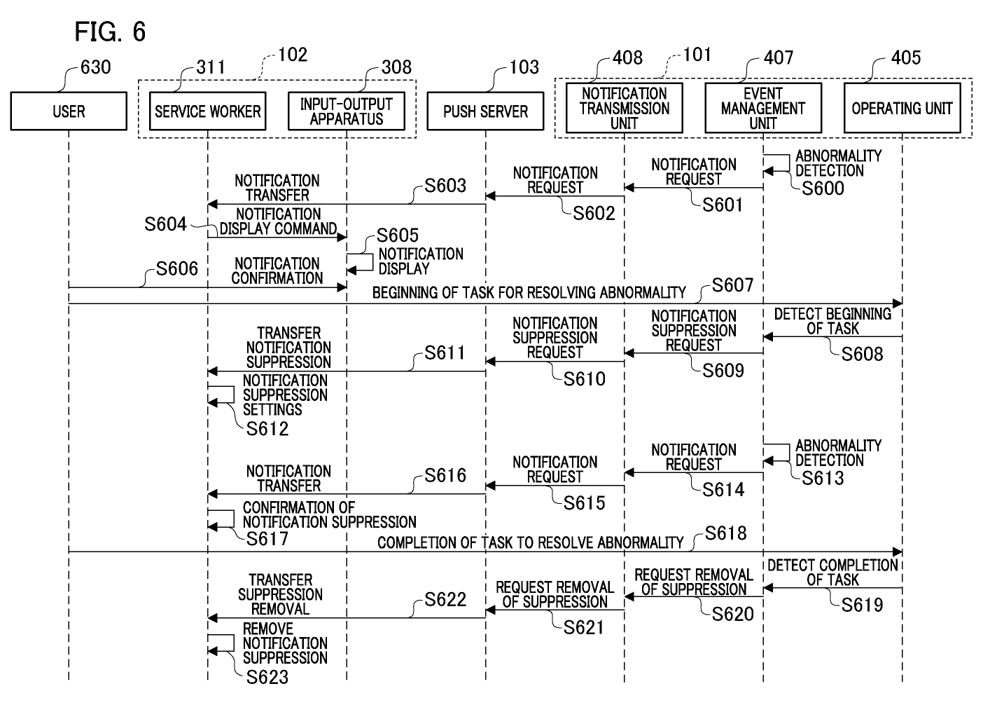

FIG. 6 will be used to explain the flow of the push notifications and the notification suppression in the information processing system in the present embodiment. FIG. 6 is a flowchart showing notification processing and notification suppression processing in the information processing system in the First Embodiment. Note that in the present context, it is made such that the mobile terminal 102 has been registered in the push server 103 as the notification destination for notifications from the image forming apparatus 101. In addition, the present embodiment, it is possible to display screens that are provided by the image forming apparatus 101 on the mobile terminal 102, which is the notification destination, as PWAs. Note that the installation method for the PWA is the same as a general installation method and therefore, an explanation thereof will be omitted.

Each type of processing that is executed by the image forming apparatus 101 in FIG. 6 is realized by the CPU 201 reading out and executing a program that has been stored on the ROM 202, and the like. Each processing that is executed by the mobile terminal 102 in FIG. 6 is realized by the CPU 301 reading out and executing a program that has been stored on the ROM 303, and the like. Each processing that is executed by the push server 103 in FIG. 6 is realized by the CPU 321 reading out and executing a program that has been stored on the ROM 323, and the like.

Each processing in FIG. 6 can be classified as abnormality detection confirmation, which is shown in S600 through S605, an abnormality resolving task, which is shown in S606 through S615, and task completion procedures, which are shown in S616 through S620. During the abnormality detection confirmation that is shown in S600 through S605, the mobile terminal 102 is notified of an abnormality that has been detected in the image forming apparatus 101. A user 630, who is the person in charge of maintenance work for the image forming apparatus 101 for which an abnormality has been confirmed, and who has received a notification, performs procedures (an abnormality resolution task) in order to resolve the abnormality in the image forming apparatus 101. Although during the abnormality resolution task, changes will occur to the settings and the device state in the image forming apparatus 101, it is unnecessary to notify the user 630 who is performing the task of the events that are caused by the abnormality resolution task. In this context, control is performed to suppress notifications during the abnormality resolution task such that the user 630 can complete the task without receiving any notifications. In the present embodiment, when an abnormality resolution task time is begun in the image forming apparatus 101, control is executed to not display notifications from the image forming apparatus 101 in the mobile terminal 102, and control is performed to restart the display of notifications from after the task completion procedure.

The notification processing that is shown in FIG. 6 is started by the trigger of the event management unit 407 of the image forming apparatus 101 having detected the occurrence of some kind of an abnormality (error) in the image forming apparatus 101. During S600, the event management unit 407 of the image forming apparatus 101 detects an abnormality in the image forming apparatus 101. During S601, the event management unit 407 of the image forming apparatus 101 transmits a request to the notification transmission unit 408 for a notification of information about the abnormality detection. During S602, the notification transmission unit 408 of the image forming apparatus 101 transmits a notification request for the abnormality detection to the push server 103 in order to notify the mobile terminal 102 that has been registered as a notification destination. The processing for S601 and S602 by the image forming apparatus 101 is notification processing for performing a notification to the mobile terminal 102 of information relating to the image forming apparatus 101 via the push service.

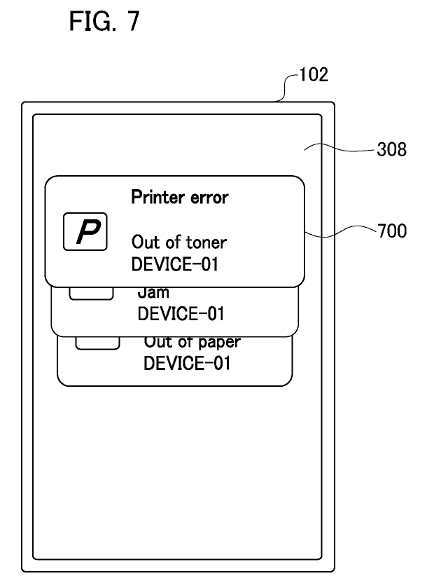

During S603, the push server 103 transmits the notification information that has been requested from the notification transmission unit 408 to the mobile terminal 102, which is the notification destination for notifications from the image forming apparatus 101 that is registered in the push server 103. The service worker (referred to below as SW) 311 of the mobile terminal 102 receives abnormality notifications from the push server 103. During S604, the SW 311 of the mobile terminal 102 commands the input-output apparatus 308 of the mobile terminal 102 to display the contents of the push notification. Note that after S603, the SW 311 may also perform processing to confirm whether or not notification suppression has been set. In a case in which notification suppression has not been set, the SW 311 performs a notification display command to the input-output apparatus 308 (S604). During S605, the input-output apparatus 308 displays the contents of the push notification. According to the above explained processing, it is possible for the image forming apparatus 101 to display, based on the notification processing, notifications of information relating to the image forming apparatus 101 in the mobile terminal 102 on the PWA that has been provided by the image forming apparatus 101. In this context, an example of the UI for the push notification is shown in FIG. 7.

FIG. 7 is a diagram showing an example of a push notification that is displayed on the input-output apparatus 308 of the mobile terminal 102 in the present application. A push notification display screen 700, which is displayed on a top page of the mobile terminal 102, is one example of a push notification display screen that displays the notification contents of a push notification. For example, a message explaining that an abnormality has occurred, detailed contents of the abnormality, and information for identifying the image forming apparatus 101 in which this has occurred are displayed on the push notification display screen 700. In the example that is shown in FIG. 7, “printer error” is displayed as the message explaining that an abnormality has occurred, “out of toner” is displayed as the detailed contents of the abnormality, and “DEVICE-01” is displayed as the information for identifying the image forming apparatus 101.

When the push notification display screen 700 is clicked, the browser 309 of the mobile terminal 102 starts up, and for example, the webpage 310, which is cached inside the mobile terminal 102, is displayed. Note that the webpage that is displayed may also be a webpage that is provided by the notification transmission unit 408 of the image forming apparatus 101. For example, detailed error information, and the state of the image forming apparatus 101 in which the error occurred are displayed on the webpage that is displayed by clicking the notification.

In this manner, in the present embodiment, when an abnormality occurs in the image forming apparatus 101 that is managed by the manager and maintenance worker, who is the user 630 of the image forming apparatus 101, a push notification is sent to the mobile terminal 102 that is being used by the user 630, and the push notification display screen 700 is displayed. By displaying a notification relating to an abnormality detection for the image forming apparatus 101 on the mobile terminal 102, it is possible for the user 630 to become aware that an abnormality has occurred in in the image forming apparatus 101. Note that although a plurality of push notification display screens are shown as being superimposed in FIG. 7, the present disclosure is not limited thereto, and each notification may also be displayed separately. In addition, the display contents are not limited to the information that is shown in FIG. 7, and the contents of the notification may also be increased and decreased.

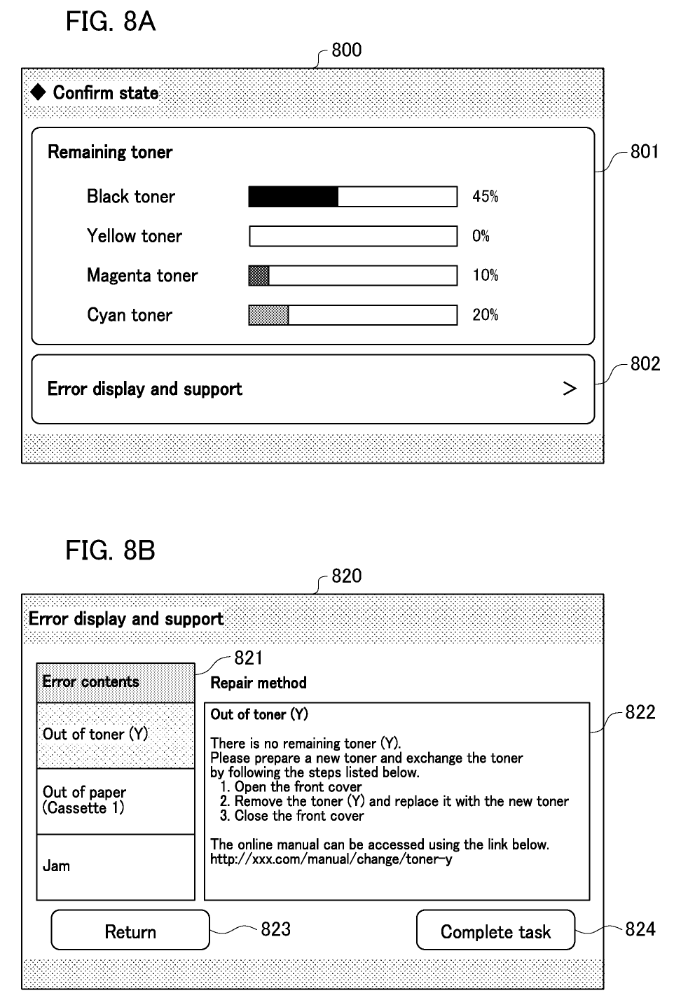

The explanation will return to FIG. 6. During S606, the user 630 confirms the notification from the image forming apparatus 101 that has been displayed on the image forming apparatus 101 during S605. The user 630 who has received the notification of the occurrence of an abnormality in the image forming apparatus 101 begins a task for resolving the abnormality according to necessity. In the present embodiment, it is assumed that the user 630 has begun the task for resolving the abnormality during S607. During S608, the event management unit 407 detects that the user 630 has begun the task. For example, the event management unit 407 detects that the user 630 has begun the task based on the user 630 having performed a specific operation. Note that that detection of the task being begun by the user 630 is not limited to a case in which a specific operation from the user 630 has been received, and this may also be a case in which a specific screen has been displayed by the user 630. In this context, an example of a UI that is displayed by the operating unit 405 in order to perform a task for resolving an error is explained in FIG. 8.

FIGS. 8A and 8B are diagrams showing one example of operating screens that are displayed by the operating unit 405. FIG. 8A is a diagram showing one example of a state confirmation screen 800 in the image forming apparatus 101. The state of the image forming apparatus 101 is displayed on the state confirmation screen 800. For example, each type of information such as the remaining toner amount 801, the error state 802, and the like of the image forming apparatus 101 is displayed on the state confirmation screen 800. When the user presses down on the error state 802, the screen that is displayed by the operating unit 405 transitions to the error support screen 820 that is shown in FIG. 8B. In the present embodiment, the operation of the user 630 pressing down the error state 802 is made a specific operation by the user 630 that is detected as the user 630 beginning that task during S608. That is, the trigger for the detection of the beginning of the task is the detection of the error state 802 on the state confirmation screen 800 being pressed down.

FIG. 8B is a diagram showing one example of an error support screen 820 in the image forming apparatus 101. When it has been detected that the error state 802 has been pressed down, the image forming apparatus 101 provides the error support screen 820. The error support screen 820 is a screen that displays error information and support information relating to the error. For example, error contents 821 and a repair method 822 therefor, a return button 823, and a response completion button 824 are displayed on the error support screen 820.

The abnormal state that is currently occurring in the image forming apparatus 101 is displayed in the error contents 821 as the error. In FIG. 8B, abnormal states such as “out of toner (y)”, which shows that there is no remaining toner, “jam”, “out of paper”, and the like are displayed as the error contents 821. A method for repairing the error that has been selected in the error contents 821 is displayed in the repair method 822.

The repair method 822 displays a repair method for the error that has been selected in the error contents 821. In FIG. 8B, as the repair method for “out of toner(y)”, steps that should be executed by the manager, the maintenance person, and the like are displayed in the repair method 822. In addition, the URL (Uniform Resource Locator) for displaying a manual is also written in the repair method 822 so as to be able to perform display of the manual by using the mobile terminal 102. Note that information corresponding to the URL such as a QR code (registered trademark), and the like, may also be displayed instead of the URL for displaying the manual.

The return button 823 is a button for transitioning the screen back to the state confirmation screen 800. The procedure completion button 824 is a button for representing that the procedures for the error that has been selected have been completed. When the image forming apparatus 101 detects that the procedure completion button 824 has been pressed down by the user 630, the error information is deleted from the error contents 821. In the present embodiment, the UI that is displayed in FIGS. 8A and 8B is one example, and in a case in which a user other than the manager and maintenance worker wishes to confirm an error, the repair method 822 and the repair completion button 824 do not need to be displayed. In addition, the date and time at which the error occurred may also be displayed on the state confirmation screen 800. Further information may also be displayed, and power consumption information and the like may also be displayed on the state confirmation screen 800.

The explanation will return to FIG. 6. When the operating unit 405 has detected a specific operation by the user 630 during S608 (for example, pressing down the error state 802 on the state confirmation screen 800), the operating unit 405 notifies the event management unit 407 that a task for resolving the abnormal state of the image forming apparatus 101 has been begun. Note that it may also be determined that a task for resolving the abnormal state of the image forming apparatus 101 has been begun in a case in which it has been detected that a specific screen (the error support screen 820) has been displayed. The event management unit 407, which has received a notification that a task for resolving the abnormal state of the image forming apparatus 101 has been begun, performs the processing for S609. S609 through S611 is processing during which a push notification for a notification suppression request is transmitted from the information forming apparatus 101 via the push server 103. The notification suppression request in the present embodiment is an action request in order to make it such that unnecessary notifications are not displayed on the mobile terminal 102 while the manager and the maintenance worker are performing the task for resolving the abnormality of the image forming apparatus 101.

During S609, the event management unit 407 performs a request (a notification request) to suppress notifications to the notification transmission unit 408. During S610, the notification transmission unit 408 of the image forming apparatus 101 transmits a notification suppression request to the push server 103. During S611, the push server 103 transmits the notification suppression request to the service worker 311 of the mobile terminal 102 by transferring the notification suppression request from the image forming apparatus 101 to the mobile terminal 102.

During S612, the service worker 311 performs control based on the notification suppression request in order to not display notifications that are transmitted from the image forming apparatus 101. In the present embodiment, the service worker 311 performs settings such that notifications for display by the input-output apparatus 308 of the mobile terminal 102 are not transmitted as the settings for not displaying the notifications that have been transmitted from the image forming apparatus 101.

S613 through S617 show the processing for the time of the detection of an abnormality after the notification suppression settings have been received. During S613, the event management unit 407 detects an abnormality in the image forming apparatus 101. In this context, the detection of an abnormality occurs by a change in the error state of the image forming apparatus 101 due to the manger and the maintenance worker resolving one abnormality (for example, “out of toner (y)”). In this case, the manager and the maintenance worker are themselves performing the task to resolve the abnormality, and therefore, it is unnecessary to notify the manager and the maintenance worker of the error due to the change in state.

S614 through S616 is processing during which a notification request from the image forming apparatus 101 is transmitted to the service worker 311 of the mobile terminal 102 via the push server 103. During S614, the event management unit 407 requests notification of information for the detection of abnormalities from the notification transmission unit 408. During S615, the notification transmission unit 408 of the image forming apparatus 101 transmits a notification request for the detection of abnormalities to the push server 103 in order to notify the mobile terminal 102 that has been registered as a notification destination. During S616, the push server 103 transfers the notification information that has been requested from the notification transmission unit 408 to the mobile terminal 102, which is the notification destination for notifications from the image forming apparatus 101 that has been registered in the push server 103. Only the contents of the abnormality that has been detected differ, and the processing for S613 through S616 is the same as the processing for S600 through S603.

During S617, the service worker 311 confirms whether or not notification suppression has been set. At the point in time of the confirmation for S615, notification suppression has been set by the processing of S610, and therefore, the service worker 311 determines that notification suppression has been set. In addition, in a case in which it has been determined that notification suppression has been set, a notification display command for the input-output apparatus 308 is not performed. Push notifications from the image forming apparatus 101 are thereby not displayed on the mobile terminal 102. Therefore, it is possible for the user 630 to focus on the task for resolving the abnormality without receiving notifications of changes to the state of the image forming apparatus 101 that are related to resolving the abnormal state.

During S618, the user 630 completes the task for resolving the abnormal state of the image forming apparatus 101. During S619, the event management unit 407 detects that the task has been completed by the user 630. For example, the event management unit 407 detects the task completion due to the error information being deleted from the error contents 821 by the repair completion button of FIG. 8B being pressed down, and all of the error information disappearing from the error contents 821. Note that it also may be made such that the event management unit 407 detects the completion of the task by the user 630 in any of a case in which a specific screen has been closed, a case in which a specific operation has been received from the user 630, a case in which the settings of the image forming apparatus 101 have been changed, and a case in which the image forming apparatus has been re-started. A specific screen is, for example, a specific screen that has been displayed in order to perform procedures (the error support screen 820). A specific operation is, for example, pressing down the repair completion button 824 on the error support screen 820. When it has been detected that the task has been completed by the user 630, the event management unit 407 notifies the event management unit 407 of the task completion.

S620 through S622 is processing for transmitting a push notification for a notification suppression removal request from the event management unit 407 to the service worker 311 of the mobile terminal 102 via the push server 103. The notification suppression removal request is processing for making it such that subsequent errors can be displayed on the mobile terminal 102 by notification because the task for resolving the abnormality has been completed. During S620, the event management unit 407 transmits a removal request for notification suppression to the notification transmission unit 408. During S621, the notification transmission unit 408 transmits the removal request for notification suppression to the push server 103. During S622, the push server 103 transmits the removal request for notification suppression to the service worker 311 of the mobile terminal 102 by transferring the removal request for notification suppression from the image forming apparatus 101 to the mobile terminal 102.

During S623, the service worker 311 performs processing in order to make it possible to display notifications that have been transmitted from the image forming apparatus 101 on the input-output apparatus 210 of the mobile terminal 102 based on the removal request for notification suppression. In the present embodiment, the service worker 311 removes the settings for notification suppression, which made it such that the input-output apparatus 308 was not notified of notifications from the image forming apparatus 101, and performs settings such that notifications will be made to the input-output apparatus 308 based on the removal request for notification suppression. When the settings for notification suppression are removed, it becomes such that subsequent notifications from the image forming apparatus 101 are displayed on the input-output apparatus 308 of the mobile terminal 102 according to processing that is the same as the processing for S600 through S605.

Note that although in the present embodiment, the pressing down of the error state 802 has been explained as the circumstance in which the beginning of the task is detected during S606, the present disclosure is not limited thereto. For example, this may also be determined by detecting the proximity of the manager and the maintenance worker using Bluetooth and the like. In the same manner, the detection of the completion of the task may also be determined by the detection that the manager and the maintenance worker have left the vicinity of the image forming apparatus. In addition, the beginning of the task may also be detected in a case in which user authentication has been performed in the image forming apparatus 101 using the authority of the manager and the maintenance worker, and in a case in which the input of a password that is only known by the manager and the maintenance worker has been received.

In addition, although in the present embodiment, an example has been explained in which control is performed such that all of the notifications from the image forming apparatus 101 are not displayed while the display of notifications is being suppressed based on the notification suppression request, the present disclosure is not limited thereto, and it may also be made such that notifications that are targets of the notification suppression can be set. For example, settings are made such that from among the notifications that have been received from the image forming apparatus 101, predetermined notifications such as notices and the like that are not related to changes in the state of the image forming apparatus 101 during the task for resolving the abnormality are not made targets of the notification suppression and can be displayed. In contrast, settings are made such that notifications that are related to events that have occurred in the image forming apparatus 101 such as the occurrence of abnormalities (errors, problems, and the like) in the image forming apparatus 101, ECO notifications, notifications of the power source being switched ON and OFF, and the like are made targets of the display suppression, and are not displayed. It is thereby possible to not display only the notifications relating to changes in the state of the image forming apparatus 101 that are caused by the task for resolving the abnormality, and to display on the mobile terminal 102 notifications that are not related to the task for resolving the abnormality such as notices from vendors, and the like.

As has been explained above, according to the present embodiment, when a network device detects the beginning of a task for resolving an abnormality by a manager and a maintenance worker, the network device sends a request to the mobile terminal 102 so as to set notification suppression that causes notifications that have been received to not be displayed. Thereby, even if notifications are received from the network device, the notifications that have been received by the mobile terminal 102 are not displayed while notification suppression is set. Therefore, it is possible for the manager and the maintenance worker to suppress the reception of unnecessary notifications during the task for resolving the abnormality in the network device.

### Second Embodiment

In the First Embodiment, control was explained that suppresses the display of notifications on an information terminal by setting notification suppression in the service worker 311 with the trigger being the beginning of a task to resolve the abnormality by a manager and a maintenance worker when the abnormality has been detected in the image forming apparatus, which is an information processing apparatus. There are also cases in which the manager and the maintenance worker would like to perform the task for resolving the error while referring to the task manual. In the First Embodiment, an example was explained in which the repair method for the abnormality was displayed in the repair method 822 of the error report screen 800 in the image forming apparatus 101. However, in a case in which the task requires that the power source for the image forming apparatus 101 be turned off at the time of the task, it is not possible to refer to the method that is displayed on the input-output apparatus 210 of the image forming apparatus 101. In this context, in the Second Embodiment, the manual for resolving the abnormality is displayed on the mobile terminal 102 at the timing of the suppression of the notifications. Below, only the portions that are different from the First Embodiment will be explained.

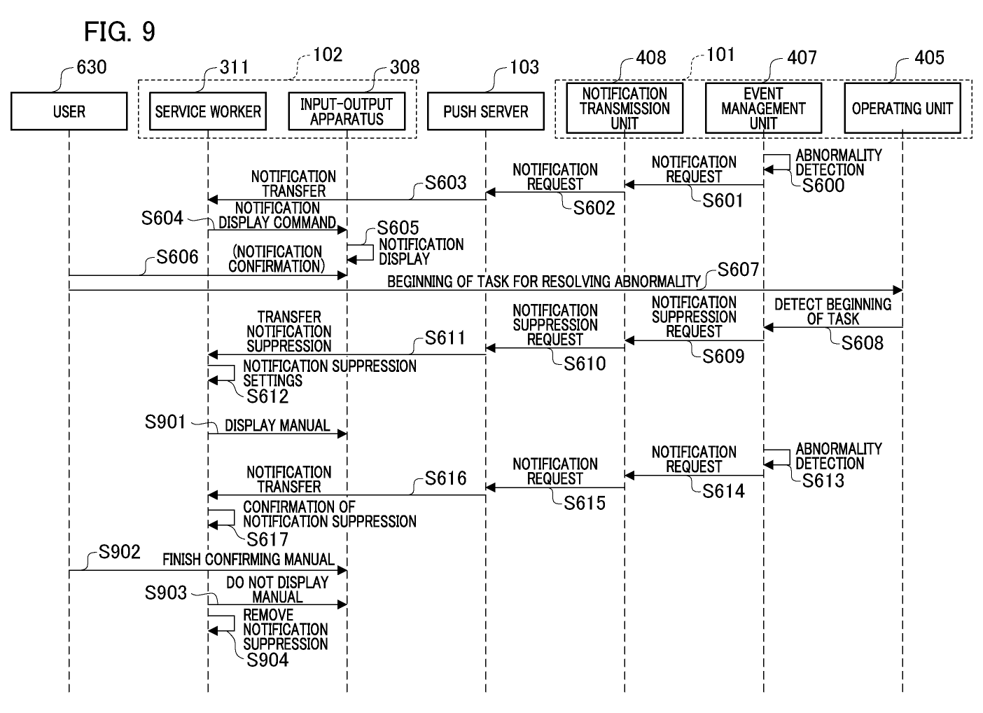

FIG. 9 is a flowchart showing notification processing and notification suppression processing in the information processing system according to the Second Embodiment. In the present embodiment, a URL that serves as a link destination for the manual is transmitted to the mobile terminal 102 from the image forming apparatus 101 together with the notification suppression request according to the processing for S609 through S611. The manual is a manual relating to procedures for resolving the abnormality in the image forming apparatus 101. The URL for the manual is, for example, a URL in which the URL that is displayed on the repair method for the error 722 has been extracted. During S612, the service worker 311 sets notification suppression, and the service worker 311 performs the processing for S901. During S901, the service worker 311 displays the manual on the input-output apparatus 308 of the mobile terminal 102. Therefore, the service worker 311 performs control for notification suppression in order to not display the notifications that are transmitted from the image forming apparatus 101 based on the request for notification suppression from the image forming apparatus 101, and also displays the manual by accessing the URL. The manual is displayed on the mobile terminal 102 by accessing the URL for the manual using the browser 309. It is thereby possible for the user 630 to perform the task for resolving the abnormality in the image forming apparatus 101 while referring to the manual for repairing the abnormality that has been displayed on the input-output apparatus 308 of the mobile terminal 102.

When the user 630 finishes the task for resolving the abnormality, during S902, the user 630 presses down the button for closing the manual that has been displayed on the mobile terminal 102. During S903, the service worker 311 detects that the button for closing the manual has been pressed down by the user 630, and stops the display of the manual that has been displayed on the input-output apparatus 308. In addition, during S904, the service worker 311 removes the notification suppression. That is, when the service worker 311 detects that the manual has been closed, it is determined that the task to resolve the abnormality has been completed by the user 630, and the service worker 311 performs control to make it possible to display notifications that are transmitted from the image forming apparatus 101.

As has been explained above, according to the present embodiment, when the task for resolving the abnormality is begun, the network device notifies the mobile terminal 102 of the URL for the manual along with the notification suppression request. It thereby becomes possible for the manager and the maintenance worker to perform the task for resolving the abnormality while referring to the manual, while also suppressing the reception of unnecessary notifications during the task for resolving the error.

### Third Embodiment

In the First Embodiment, control was explained that suppresses the display of notifications on an information terminal by setting notification suppression in the service worker 311 with the trigger being the beginning of a task to resolve the abnormality by a manager and a maintenance worker when the abnormality has been detected in the image forming apparatus, which is an information processing apparatus. Therefore, in the First Embodiment, notifications from the image forming apparatus 101 to the mobile terminal 102 were performed even during the suppression of notifications. Therefore, in the present embodiment, it is made such that the mobile terminal 102 does not receive unnecessary abnormality detection notifications from the image forming apparatus 101. Specifically, it is made such that the mobile terminal 102 does not receive unnecessary abnormality detection notifications by suppressing notifications from the image forming apparatus 101 to the push server 103. Below, only the portions that differ from the First Embodiment will be explained.

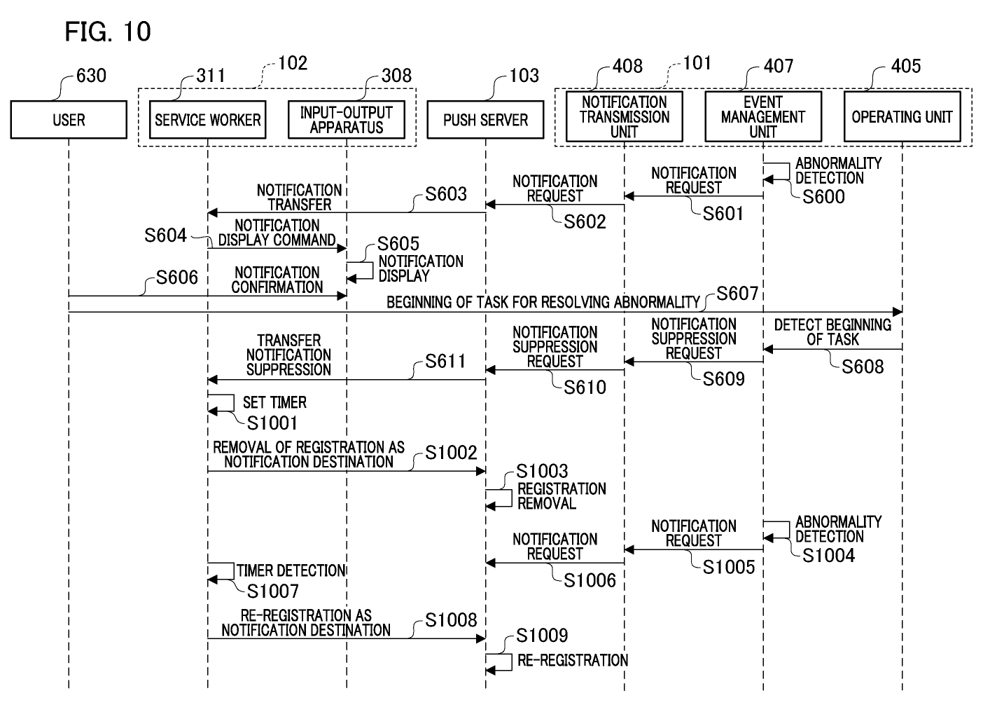

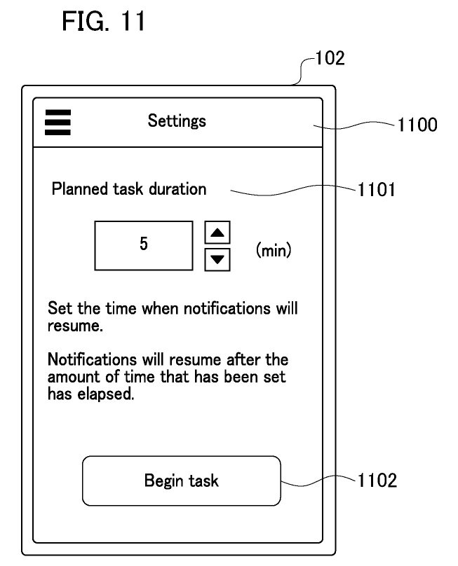

FIG. 10 is a flowchart showing the notification processing and the notification suppression processing in the information processing system of the Third Embodiment. During S611, the service worker 311, which has received a notification suppression setting request from the push server 103, performs the processing for S1001 and S1002. During S1001, the service worker 311 provides a timer setting screen and thereby receives settings for the time when notifications that are transmitted from the image forming apparatus 101 will not be displayed based on the notification suppression request. In the present embodiment, settings for a planned task completion time are received as the time during which notifications will not be displayed. Note that the time that the task will take may also be set to serve as the timer. instead of setting the completion time for the task. The timer settings are set, for example, by the user 630 on the timer setting screen. Therefore, when the task for resolving the abnormality of the image forming apparatus 101 is begun and the service worker 311 receives the notification suppression command from the push server 103, the timer setting screen is displayed on the input-output apparatus 308. In this context, an example of the timer setting screen that is displayed on the input-output apparatus 308 will be explained using FIG. 11.

FIG. 11 is a diagram showing one example of a timer setting screen. The timer setting screen 1100 is displayed on the PWA of the mobile terminal 102. For example, the timer setting screen 1100 displays, on the PWA, the webpage 310 that is provided by the notification transmission unit 408. The timer setting screen 1100 is a screen on which the time that will be taken by the task to resolve the abnormality is set. For example, a time setting controller 1101, and a begin task button 1102 are displayed on the timer setting screen 110.

The time setting controller 1101 is a controller that sets the time that will be taken by the task for resolving the abnormality. The time until the timer is detected changes based on the time that has been set by the time setting controller 1101. The begin task button 1102 is a button that becomes a trigger for the validity of the timer. In addition, the begin task button 1102 is also a button that becomes a trigger for commanding the removal of registration as a notification destination in the push server 103. The user 630 sets the time that they predict will be taken by the task for resolving the abnormality on the time setting controller 1101, and presses down the begin task button 1102. When the pushing down of the begin task button 1102 has been detected, the mobile terminal 102 performs the processing for S1002.

The explanation will return to FIG. 10. During S1002, the service worker 311 performs control such that notifications that are transmitted from the image forming apparatus 101 will not be displayed based on the notification suppression request. In the present embodiment, the service worker 311 performs a request such that the information for the mobile terminal 102 is deleted from the notification destinations for notifications from the image forming apparatus 101 that are registered in the push server 103. That is, the service worker 311 transmits a removal request to the push server 103 such that the registration of the mobile terminal 102 as a notification destination for notifications from the image forming apparatus 101 is removed. During S1003, the push server 103 deletes the mobile terminal 102 from the target list for notification destinations for notifications from the image forming apparatus 101 that is managed by the push server 103. The mobile terminal is thereby removed as a registered notification destination for the image forming apparatus 101.

After the mobile terminal 102 has been removed from the registered notification destinations, when an abnormality is detected in the image forming apparatus 101, the processing for S1004 through S1005 is performed. During S1004, the event management unit 407 detects an abnormality in the image forming apparatus 101. During S1005, the event management unit 407 performs a notification request to the notification transmission unit 408. During S1006, the notification transmission unit 408 performs a notification request to the push server 103. The mobile terminal 102 has been removed from the registered notification destinations in the push server 103, and therefore, a push notification by transfer of the notification request to the mobile terminal 102 is not performed. The notification from the image forming apparatus 101 thereby does not reach the mobile terminal 102.

During S1007, the service worker 311 detects the triggering of the timer. The timer is triggered when the amount of time that has been set elapses from when the removal of registration as a notification destination for abnormality detection was performed. In addition, during S1008, the service worker 311 transmits a registration request to the push server 103 such that the mobile terminal 102 is registered as a notification destination for notifications from the image forming apparatus 101. That is, the service worker 311 performs control in order to make it possible to display notifications that are transmitted from the image forming apparatus 101 according to the time that was set on the timer setting screen having elapsed. During S1009, the push server 103 re-registers the mobile terminal 102 as a notification destination for notifications from the image forming apparatus 101 based on the registration request from the mobile terminal 102. According to the re-registration of the mobile terminal 102 as a notification destination, it becomes such that in a case in which an abnormality is detected in the image forming apparatus 101, the mobile terminal 102 is also notified by the push server 103 transferring the notification from the image forming apparatus 101.

According to the above-described processing, it is possible to exclude the mobile terminal 102 from the notification destinations that are registered in the push server 103 for just a specific time during which the user 630 is performing the task for resolving the abnormality of the image forming apparatus 101. It thereby becomes possible to perform control such that notifications to the mobile terminal 102 from the push server 103 are not performed, and it is possible to temporality suppress notifications from the image forming apparatus 101.

Note that it is also possible to apply the settings for the timer that were explained in the present embodiment to the First Embodiment. That is, the service worker 311 performs control such that notifications that have been received from the image forming apparatus 101 are not displayed on the input-output apparatus 308 of the mobile terminal 102 for just the period of time that was set on the timer setting screen. In addition, it is also possible to execute the processing to temporality stop push notifications that was explained in the present embodiment without setting the timer. That is, when a request for notification suppression is received from the image forming apparatus 101, the service worker 311 requests the removal of registration as a notification destination in the push server 103. In addition, when the removal request for the notification suppression is received from the image forming apparatus 101, the service worker 311 requests registration as a notification destination in the push server 103.

Note that although in the present embodiment, an example has been explained in which the terminal that becomes the target for the processing to remove notification registration (S1003) is limited to the mobile terminal 102, which is the request source, the present disclosure is not limited thereto. For example, all of the mobile terminals that are subscribed to the target image forming apparatus 101 may also be made targets, and registration may also be removed for only a portion of mobile terminals for which notifications are unnecessary during the task. For example, the targets of the removal as a notification destination are managed by the notification transmission unit (application server) 408 of the image forming apparatus 101, and the like.

In addition, although in the present embodiment, in a case in which the timer setting time was too short, the notifications will re-start, in this case, a screen to re-set the timer may also be displayed. In addition, a button for commanding the completion of the task may also be prepared on the timer setting screen, and it may also be made such that in a case in which there has been such a command, the re-registration of notifications is performed without waiting for the timer to elapse. Furthermore, although in the present embodiment, the timer settings were displayed based on the trigger of the task being begun, the present disclosure is not limited thereto, and these may also be set at the time of the installation of the PWA on the mobile terminal 102.

Above, according to the present embodiment, a manager and a maintenance worker can suppress the reception of unnecessary notifications during the task for resolving the abnormality. In addition, it is possible for the terminal (mobile terminal 102) to suppress notifications from being sent by removing itself as a notification destination that is registered on the push server 103.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-042135, filed Mar. 17 2024, which is hereby incorporated by reference herein in its entirety.

What is claimed is:

1. A network device configured to provide a website comprising information about the network device, the network device comprising:
a memory storing instructions; and
a processor executing the instructions, causing the network device to:
execute notification processing for performing notifications of information relating to the network device via a push service to an application that has been installed on a terminal by accessing the website and that has at least one function of the website;
transmit, to the application via the push service, a request for suppression of the notifications when beginning of procedures to resolve an abnormality of the network device has been detected; and
transmit, to the application via the push service, a request to remove the suppression of the notifications when completion of the procedures is detected.

2. The network device according to claim 1, wherein the beginning of the procedures to resolve the abnormality in the network device is detected in a case in which a specific operation from a user has been received, and in a case in which a specific screen has been displayed.

3. The network device according to claim 1, wherein the completion of the procedures is detected in any of a case in which a specific operation has been received from the user, a case in which a specific screen that was displayed in order to perform the procedures has been closed, a case in which settings of the network device have been changed, and a case in which the network device has been restarted.

4. The network device according to claim 1, wherein
settings are performed in the terminal such that the terminal is not notified of information relating to the network device via a display unit of the terminal based on the processing that is based on the request to suppress the notifications; and
the settings are removed in the terminal based on the request to remove the suppression of the notifications.

5. The network device according to claim 4, wherein the information relating to the network device based on the notification processing that will become a target of settings to not notify the terminal via the display unit of the terminal is information relating to an event that has occurred in the network device.

6. The network device according to claim 1, wherein when the processor of the network device transmits the request for the suppression of the notifications to the application, a URL for displaying a manual relating to the procedures for resolving the abnormality in the network device is also transmitted; and
in the terminal, settings to not notify the terminal of the information relating to the network device via the display of the terminal based on the notification processing that is based on the request for the suppression of the notifications is performed, and the settings are removed in a case in which the manual was displayed on the display of the terminal by accessing the URL and the manual has been closed.

7. The network device according to claim 1, wherein
in the terminal, a removal request to remove the terminal from notification destinations for notifications from the network device that are registered in the push service is transmitted to the push service based on the request for the suppression of the notifications;
in the push service, the terminal is removed from the notification destinations for notifications from the network device that are registered in the push service according to the removal request from the terminal;
in the terminal, a registration request to register the terminal in the notification destinations for notifications from the network device that are registered in the push service is transmitted to the push service based on the request to remove the suppression of the notifications; and
in the push service, the terminal is registered as a notification destination for notifications from the network device according to the registration request from the terminal.

8. The network device according to claim 7, wherein:
in the terminal, a timer settings screen is provided, and settings of a time during which notifications that are transmitted from the network device will not be displayed are accepted based on the request for the suppression of the notifications, control is performed to not display information relating to the network device based on the notification processing, and, in accordance with the expiration of the set time, control is performed in order to resume display of the information relating to the network device based on the notification processing.

9. A method for controlling a network device that is configured to provide a website comprising information for the network device, the method comprising:
executing notification processing for performing notifications of information relating to the network device via a push service to an application that has been installed on a terminal by accessing the website and that has at least one function of the website;
transmitting, to the application via the push service, a request for suppression of the notifications when beginning of procedures to resolve an abnormality of the network device has been detected; and
transmitting, to the application via the push service, a request to remove the suppression of the notifications when completion of the procedures is detected.

10. A non-transitory storage medium storing a control program of a network device causing a computer to perform each step of a control method of the network device, the method comprising:
executing notification processing for performing notifications of information relating to the network device via a push service to an application that has been installed on a terminal by accessing the website and that has at least one function of the website;
transmitting, to the application via the push service, a request for suppression the notifications when beginning of procedures to resolve an abnormality of the network device has been detected; and
transmitting, to the application via the push service, a request to remove the suppression of the notifications when completion of the procedures is detected.
